(19) United States
(12) Patent Application Publication
(10) Pub. No.: US 2024/0357617 A1
(43) Pub. Date: Oct. 24, 2024

(54) PHYSICAL DOWNLINK CONTROL CHANNEL CONFIGURATION

(71) Applicant: Nokia Technologies Oy, Espoo (FI)

(72) Inventors: Esa Tapani TIIROLA, Oulu (FI); Timo Erkki LUNTTILA, Espoo (FI)

(21) Appl. No.: 18/562,642

(22) PCT Filed: Jan. 5, 2022
(86) PCT No.: PCT/EP2022/050112

§ 371 Date: Nov. 20, 2023

(51) Int. Cl. H04W 72/232; H04W 72/044

(52) U.S. Cl. CPC H04W 72/232; H04W 72/044

(57) ABSTRACT

Systems, methods, apparatuses, and computer program products for search space configuration for multi-slot physical downlink control channel (PD-CCH) monitoring scenarios. A method may include determining that a search space relates to a subcarrier spacing and to multi-slot physical downlink control channel monitoring. The method may also include receiving configuration for a number of X slots in a slot group and a number of Y slots with monitoring occasions, and a location of Y slots within a slot group of X slots. The method may further include receiving a first configuration for a given physical downlink control channel search space. In addition, the method may include monitoring a physical downlink control channel corresponding to the search space based on values of X and Y.

### FIELD

Some example embodiments may generally relate to mobile or wireless telecommunication systems, such as Long Term Evolution (LTE) or fifth generation (5G) new radio (NR) access technology, or other communications systems. For example, certain example embodiments may relate to apparatuses, systems, and/or methods for search space configuration for multi-slot physical downlink control channel (PDCCH) monitoring scenarios.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, fifth generation (5G) radio access technology or new radio (NR) access technology, NR Rel-17, NR-Advanced, and/or 6G (e.g., for frequency band scenarios greater than 71 GHz). Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Some example embodiments may be directed to a method. The method may include determining that a search space relates to a subcarrier spacing and to multi-slot physical downlink control channel monitoring. The method may also include receiving configuration for a number of X slots in a slot group and a number of Y slots with monitoring occasions, and a location of Y slots within a slot group of X slots. The method may further include receiving a first configuration for a given physical downlink control channel search space. According to certain example embodiments, the configuration may include indicated values of a search space monitoring periodicity and values of an offset. In addition, the method may include monitoring a physical downlink control channel corresponding to the search space based on values of X and Y.

Other example embodiments may be directed to an apparatus. The apparatus may include at least one processor and at least one memory including computer program code. The at least one memory and computer program code may also be configured to, with the at least one processor, cause the apparatus at least to determine that a search space relates to a subcarrier spacing and to multi-slot physical downlink control channel monitoring. The apparatus may also be caused to receive configuration for a number of X slots in a slot group and a number of Y slots with monitoring occasions, and a location of Y slots within a slot group of X slots. The apparatus may further be caused to receive a first configuration for a given physical downlink control channel search space. According to certain example embodiments, the configuration may include indicated values of a search space monitoring periodicity and values of an offset. In addition, the apparatus may be caused to monitor a physical downlink control channel corresponding to the search space based on values of X and Y.

Other example embodiments may be directed to an apparatus. The apparatus may include means for determining that a search space relates to a subcarrier spacing and to multi-slot physical downlink control channel monitoring. The apparatus may also include means for receiving configuration for a number of X slots in a slot group and a number of Y slots with monitoring occasions, and a location of Y slots within a slot group of X slots. The apparatus may further include means for receiving a first configuration for a given physical downlink control channel search space. According to certain example embodiments, the configuration may include indicated values of a search space monitoring periodicity and values of an offset. In addition, the apparatus may include means for monitoring a physical downlink control channel corresponding to the search space based on values of X and Y.

In accordance with other example embodiments, a non-transitory computer readable medium may be encoded with instructions that may, when executed in hardware, perform a method. The method may include determining that a search space relates to a subcarrier spacing and to multi-slot physical downlink control channel monitoring. The method may also include receiving configuration for a number of X slots in a slot group and a number of Y slots with monitoring occasions, and a location of Y slots within a slot group of X slots. The method may further include receiving a first configuration for a given physical downlink control channel search space. According to certain example embodiments, the configuration may include indicated values of a search space monitoring periodicity and values of an offset. In addition, the method may include monitoring a physical downlink control channel corresponding to the search space based on values of X and Y.

Other example embodiments may be directed to a computer program product that performs a method. The method may include determining that a search space relates to a subcarrier spacing and to multi-slot physical downlink control channel monitoring. The method may also include receiving configuration for a number of X slots in a slot group and a number of Y slots with monitoring occasions, and a location of Y slots within a slot group of X slots. The method may further include receiving a first configuration for a given physical downlink control channel search space. According to certain example embodiments, the configuration may include indicated values of a search space monitoring periodicity and values of an offset. In addition, the method may include monitoring a physical downlink control channel corresponding to the search space based on values of X and Y.

Other example embodiments may be directed to an apparatus that may include circuitry configured to determine that a search space relates to a subcarrier spacing and to multi-slot physical downlink control channel monitoring. The apparatus may also include circuitry configured to receive configuration for a number of X slots in a slot group and a number of Y slots with monitoring occasions, and a location of Y slots within a slot group of X slots. The apparatus may further include circuitry configured to receive a first configuration for a given physical downlink control channel search space. According to certain example embodiments, the configuration may include indicated values of a search space monitoring periodicity and values of an offset. In addition, the apparatus may include circuitry configured to monitor a physical downlink control channel corresponding to the search space based on values of X and Y.

### BRIEF DESCRIPTION OF THE DRAWINGS

For proper understanding of example embodiments, reference should be made to the accompanying drawings, wherein:

FIG. 1 illustrates an example visualization of multi-slot physical downlink control channel capabilities.

FIG. 2 illustrates an example procedure for a gNB generating a PDCCH.

FIG. 3 illustrates example configuration tables, according to certain example embodiments.

FIG. 4 illustrates another example configuration table, according to certain example embodiments.

FIG. 5 illustrates an example flow diagram of a method, according to certain example embodiments.

FIG. 6 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for power saving for search space configuration for multi-slot physical downlink control channel (PDCCH) monitoring scenarios.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

3^{rd} Generation Partnership Project (3GPP) New Radio (NR) supports NR from 52.6 GHz to 71 GHz. Additionally, 3GPP has carried out changes to NR using existing downlink/uplink (DL/UL) waveform to support operations between 52.6 GHz and 71 GHz. As to multi-slot monitoring, 3GPP describes certain elements of different PDCCH search space (SS) groups. For example, for group (1) SS, a type 1 common search space (CSS) set is defined with a dedicated radio resource control (RRC) configuration, a type 3 CSS, an a UE specific SS. In group (1) SS, an SS may be monitored within Y consecutive slots within a slot group of X slots. Additionally, the Y consecutive slots may be located anywhere within the slot group of X slots. In some cases, there may be no requirement to align the Y consecutive slots across UEs or with slot no. In some cases, no may be the first slot where the UE searches the PDCCH for system information block 1 (SIB1) for certain synchronization signal block (SSB) beam. Additionally, the location of n0 with respect to the SSB may be determined by a physical broadcast channel (PBCH). Further, the location of the Y consecutive slots within the slot group of X slots may be maintained across different slot groups. In addition, PDCCH blind decoding (BD) attempts for all group (1) SSs may be restricted to fall within the same Y consecutive slots.

3GPP also defines group (2) SS where type 1 CSS set is defined without a dedicated RRC configuration and type 0, 0A, and 2 CSS. Here, SS monitoring locations may be anywhere within a slot group of X slots, with the exception that BD attempts for Type0-CSS for SSB/CORESET 0 multiplexing pattern 1, and additionally for Type0A/2-CSS if searchSpaceId=0, occur in slots with index n0 and n0+X0. Here, n is as in 3GPP Rel-15, and X0=4 for 480 kHz SCS, and X0=8 for 960 kHz SCS.

3GPP also supports combinations of (X,Y). For instance, a UE capable of multi-slot monitoring may support, for SCS 480 kHz, (X,Y)=(4,1). For SCS 960 kHz, the UE may support, for SCS 960 kHz, (X,Y)=(8,1). In other cases, the UE capable of multi-slot monitoring may optionally support, for SCS 480 kHz, (X,Y)=(4,2), and for SCS 960 kHz, (X,Y)=(8,4), (4,2), and (4,1).

In the case where a UE is capable of multi-slot monitoring, the UE may support various elements related to PDCCH monitoring within Y slots. These elements may define, for example, what are the valid OFDM symbols within Y slots for PDCCH monitoring. For instance, for Y>1, FG3-1 (monitoring group (1) SSs in the first 3 orthogonal frequency-division multiplexing (OFDM) symbols of each of the Y slots). For a 960 kHz SCS and Y=1, FG3-5b may be configured with set1=(7,3). Here, the first number is the minimum gap in symbols between the start of two spans, and the second number is the span duration in symbols.

Additionally, for a 480 kHz SCS and Y=1, FG3-5b may be configured with set2=(4,3) and (7,3) with a modification with maximum two monitoring spans in a slot. Here, the first number is the minimum gap in symbols between the start of two spans, and the second number is the span duration in symbols. In some cases, the definitions of FG3-5b and FG3-1 may be superseded by processing one unicast downlink control information (DCI) scheduling DL, and one unicast DCI scheduling UL per slot group of X slots per scheduled component carrier (CC) for frequency division duplex (FDD). Alternatively, definitions of FG3-5b and FG3-1 may be superseded by processing one unicast DCI scheduling DL and 2 unicast DCI scheduling UL per slot group of X slots per scheduled CC for time division duplex (TDD).

Furthermore, 3GPP defines certain limits that may be applicable for multi-slot monitoring within the groups of X slots. For instance, the maximum number of monitored PDCCH candidates per X=4 slots for a DL bandwidth part (BWP) with 480 kHz SCS configuration for a single serving cell may be 20. Further, the maximum number of monitored PDCCH candidates per X=8 slots for a DL BWP with 960 kHz SCS configuration for a single serving cell may be 20. Additionally, the maximum number of non-overlapped CCEs per X=4 slots for a DL BWP with 480 kHz SCS configuration for a single serving cell may be 32, and the maximum number of non-overlapped CCEs per X-8 slots for a DL BWP with 960 kHz SCS configuration for a single serving cell may be 32.

As described in 3GPP, the parameter monitoringSlotPeriodicityAndOffset may be provided. This parameter may relate to slots for PDCCH monitoring configured as periodicity and offset. Additionally, it may correspond to L1 parameters “monitoring-periodicity PDCCH-slot” and “monitoring-offset-PDCCH-slot”. For example, if the value (“monitoring-periodicity-PDCCH-slot”) is sl1, it means that the UE should monitor the SS at every slot. However, if the value is sl4, it means that the UE should monitor the SS in every fourth slot. Further, “monitoring-offset-PDCCH-slot” may be a configurable integer value that defines the actual slot with PDCCH monitoring (within the period defined by the periodicity). However, certain problems arise in conventional configurations. For example, there may be a limited maximum periodicity (in terms of ms). Additionally, there may be values that are not compatible with multi-slot monitoring, since at least part of the monitoring occasions may be outside of the Y slots. This means that there may be error cases that need specific handling. Furthermore, there may be a limited coexistence with other numerologies (especially 120 kHz SCS). In particular, 120 kHz SCS may be the basic numerology for FR2-2 supported by UEs.

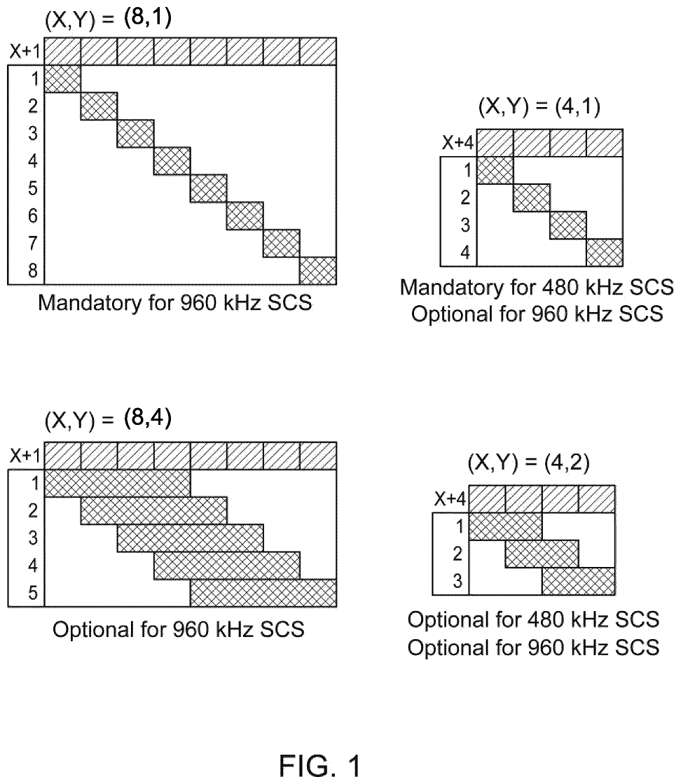

FIG. 1 illustrates an example visualization of multi-slot PDCCH capabilities. As described herein, certain example embodiments may consider how to configure PDCCH SSs (SS group (1)) such that they would support multi-slot PDCCH capabilities, as illustrated FIG. 1. In particular, as illustrated in FIG. 1, X may represent the number of slots in the slot group, and Y may represent the slot(s) with monitoring occasions for SS group (1). FIG. 1 also illustrates all possible locations for Y. The location of the Y consecutive slots within the slot group of X slots may be maintained across different slot groups. Thus, certain example embodiments may configure PDCCH SS such that all monitoring occasions fall in predefined symbols of Y slots appearing with a periodicity of X slots.

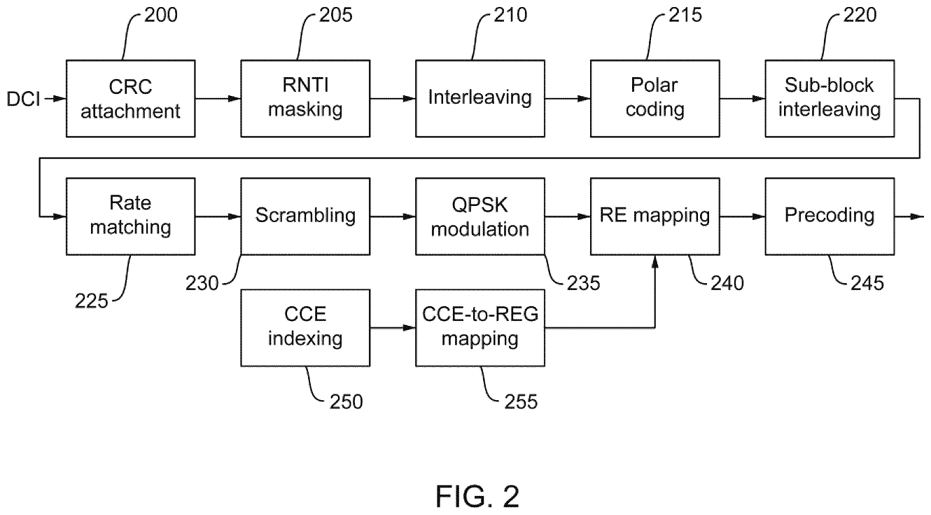

FIG. 2 illustrates an example procedure for a gNB generating a PDCCH. If the size of the DCI format is less than 12 bits, a few zero padding bits may be appended until the payload size equals 12bits. At 200, for the DCI payload bits, a 24-bit cyclic redundancy check (CRC) may be calculated and appended to the payload. The CRC allows the UE to detect the presence of errors in the decoded DCI payload bits. At 205, after the CRC is attached, the last 16 CRC bits may be masked with a corresponding identifier, referred to as a radio network temporary identifier (RNTI). Using the RNTI mask, the UE can detect the DCI for its unicast data and distinguish sets of DCI with different purposes that have the same payload size. At 210, the CRC attached bits may then be interleaved to distribute the CRC bits among the information bits. The interleaver may support a maximum input size of 164 bits. This means that DCI without CRC can have at most 140 of payload bits. At 215, the bits may then be encoded by a Polar encoder to protect the DCI against errors during transmission. At 220, the encoder output may be processed using a sub-block interleaver, and then at 235, rate matched to fit the allocated payload resource elements (REs) of the DCI.

At 230, the payload bits of each DCI may be separately scrambled by a scrambling sequence generated from the length-31 Gold sequence. The scrambling sequence may be initialized by the physical layer cell identity of the cell or by a UE specific scrambling identity and a UE specific cell RNTI (C-RNTI). At 235, after the scrambled DCI bit sequence is Quadrature Phase Shift Keying (QPSK) modulated, at 240, the complex-valued modulation symbols may be mapped to physical resources in units referred to as control channel elements (CCEs). At 250 and 255, each CCE may include six resource element groups (REGs), where a REG is defined as one PRB in one OFDM symbol which contains nine REs for the PDCCH payload and three demodulation reference signal (DMRS) REs. Additionally, in verifying the number of CCEs at 250, the gNB may adjust the coding rate for PDCCH. For each DCI, 1, 2, 4, 8, or 16 CCEs can be allocated, where the number of CCEs for a DCI is denoted as aggregation level (AL). With QPSK modulation, a CCE may include 54 payload REs and therefore can carry 108 bits. In this case, the output size of the rate matching block may be L·108, where L is the associated AL. Based on the channel environment and available resources, the gNB can adaptively choose a proper AL for a DCI to adjust the code rate. The precoding block (245) may allow the gNB to change the antenna precoder weights between different REG bundles (while maintaining the precoding within the REG bundle). This provides the ability to achieve transmit diversity for the 1-port PDCCH transmission involving more than one Tx antenna.

Furthermore, a DCI with AL=L may be mapped to physical resources in a given BWP, where necessary parameters such as frequency and time domain resources, and scrambling sequence identity for the DMRS for the PDCCH are configured to a UE by means of control resource set (CORESET). In addition, a UE may be configured with up to three CORESETs in 3GPP Rel-15 and up to five CORESETs in 3GPP Rel-16 (for multi-DCI multi-TRP operation) on each of up to four BWPs of a serving cell. In general, CORESETs may be configured in units of six PRBs on a six PRB frequency grid and one, two, or three consecutive OFDM symbols in the time domain.

A DCI of AL=L may include L continuously numbered CCEs, and the CCEs may be mapped on a number of REGs in a CORESET. NR supports distributed and localized resource allocation for a DCI in a CORESET. This may be done by configuring interleaved or non-interleaved CCE-to-REG mapping for each CORESET (255). For interleaved CCE-to-REG mapping, REG bundles constituting the CCEs for a PDCCH may be distributed in the frequency domain in units of REG bundles. A REG bundle is a set of indivisible resources consisting of neighbouring REGs. A REG bundle may span across all OFDM symbols for the given CORESET. Once the REGs corresponding to a PDCCH are determined, the modulated symbols of the PDCCH are mapped to the REs of the determined REGs in the frequency domain first and the time domain second (i.e., in increasing order of the RE index and symbol index, respectively).

The UE may also perform blind decoding for a set of PDCCH candidates. In particular, PDCCH candidates to be monitored may configured for a UE by means of search space (SS) sets. There may be two SS set types: a common SS (CSS) set, which is commonly monitored by a group of UEs in the cell; and UE-specific SS (USS) set, which is monitored by an individual UE. A UE may be configured with up to 10 SS sets each for up to four BWPs in a serving cell. Further, the SS set configuration may provide a UE with the SS set type (CSS set or USS set), DCI format(s) to be monitored, monitoring occasion, and the number of PDCCH candidates for each AL in the SS set.

An SS set with index s may be associated with one CORESET with index p. The UE may determine the slot for monitoring the SS set with index s based on the higher layer parameters for periodicity k, offset o, and duration d, where periodicity k and offset o provide a starting slot and duration d provides the number of consecutive slots where the SS set is monitored starting from the slot identified by k and o.

As to PDCCH monitoring, the mapping of PDCCH candidates of an SS set to CCEs of the associated CORESET may be implemented by means of a hash function. The hash function randomizes the allocation of the PDCCH candidates within CORESET. Furthermore, the UE may be monitoring PDCCH on the certain CORESET based on the activated TCI state of the CORESET. The TCI state may provide the UE with two QCL-Type source RSs at carrier frequencies where receive beamforming is applied. One of the source RSs may be the QCL-TypeD source based on which the UE is able to set its receive beam properly. The UE may be able to receive PDCCH with the same RX beam as it used to receive the given QCL-TypeD source RS. Before the UE has been provided TCI state for PDCCH monitoring, the UE may apply the SSB used in the random access.

NR may provide support for overbooking functionality, where a UE can be configured with (temporarily) more PDCCH monitoring than supported by the UE. The UE capability defined separately for different SCSs covers a number of control channel blind decoding attempts (BD) that the UE needs to perform at least, and the number of non-overlapping control channel elements (CCEs) that the UE should be able to demodulate. If the number of BDs/CCEs is exceeded for a certain monitoring occasion, the UE may not need to monitor certain SSs, and they may be dropped (i.e., not monitored).

There may be various ways to determine BD/CCE dropping rules. For example, in one approach, BD/CCE dropping may be defined per slot, based on the UE's capabilities. In another approach (defined for URLLC scenarios), the UE may be configured to follow a span-based operation. In a span-based operation, CCE processing and BD capabilities may be defined per span. Further, a span may include up to Y consecutive symbols, and the operation may be defined based on two parameters, X and Y. In particular, X (slots) may be the minimum time separation between the first symbols of two consecutive spans, and Y (slots) may be the maximum duration of the span.

Certain example embodiments may implement PDCCH monitoring with 480 kHz or 960 kHz SCS, for instance. This may be associated to multi-slot capability defined by the combination of (X,Y). In other example embodiments, the PDCCH monitoring may be available for SSs configurable by RRC (i.e., SS group (1)).

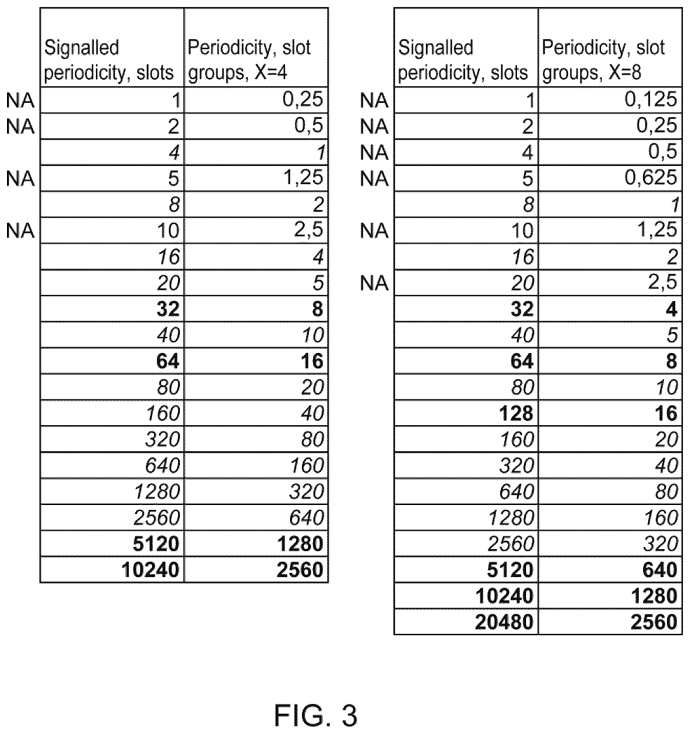

According to certain example embodiments, the PDCCH monitoring configuration with 480 kHz or 960 kHz SCS may be made by means of a configuration table or RRC parameter (monitoringSlotPeriodicityAndOffset_R17) or redefined RRC parameter (monitoringSlotPeriodicityAndOffset) constructed in the following way. In particular, the table may be associated with the parameter X (i.e., slot group size). According example to certain embodiments, the monitoringSlotPeriodicityAndOffset_R17 may be similar to the parameter monitoringSlotPeriodicityAndOffset described above (i.e., Rel-15/16 parameter defining “monitoring-periodicity-PDCCH-slot” and “monitoring-offset-PDCCH-slot”). In some example embodiments, separate tables may be defined for X=4 and X=8 (i.e., for 480 kHz and 960 kHz SCS). In other example embodiments, the tables may be created based on the existing monitoringSlotPeriodicityAndOffset table by, for example, keeping slot periodicities multiple of X slots (i.e., 4 slots for 480 kHz, and 8 slots for 960 kHz). Additionally, the tables may be created by removing slot periodicities not multiple of 4 or 8 slots, for SCS of 480 kHz and 960 kHz, respectively. Furthermore, the tables may be created by adding periodicities to match monitoringSlotPeriodicities (in terms of absolute time) available for 120 kHz SCS, corresponding to X times the periodicity in the 120 kHz case. The outcome of these operations is illustrated in the example of FIG. 3. Specifically, the table on the left is for the case X=4, and the table on the right is for the case X=8.

As illustrated in the example of FIG. 3, the left column shows the RRC signaled periodicity (+associated slot offset) according to monitoringSlotPeriodicityAndOffset_R17. The associated slot offset may tell the slot where the actual PDCCH monitoring is taking place. For example, if the signaled periodicity is 8 slots, three bits are needed to indicate the exact slot (one out of 8 slots) with PDCCH monitoring. The other 7 slots are not monitored. Further, the offset can be determined with respect to the known reference (e.g., subframe and/or radio frame boundary). Further, the right column shows that actual periodicity in terms of slot groups. According to certain example embodiments, for each periodicity, there may be a separate indication of the slot offset with as many values as there are in each entry in the left column of the table. Alternatively, the offset may be indicated with a resolution of X slots, while the parameter monitoringSymbolsWithinSlot is increased by a factor of X. The parameter monitoringSymbolsWithinSlot may relate to symbols for PDCCH monitoring in the slots configured for PDCCH monitoring. This may be accomplished with a bitmap of 14 bits. The most significant (left) bits represents the first OFDM symbol in a slot, and the least significant (right) bit represents the last OFDM slot. Further, the monitoringSymbolsWithinSlot indicates the starting OFDM symbols that the UE should search for a SS. For instance, in certain example embodiments, if the value is “1000000000000”, it means that the UE should start searching from the first OFDM symbol. If the value is “0100000000000”, it means that the UE should start searching from the second OFDM symbol.

According to certain example embodiments, the slot offset values for the new entries (e.g., 5120, 10240, 20480) may be upper limited by the maximum range of the current table (i.e., 2560). This means that the RRC signaling overhead does not change compared to 3GPP Rel-15. According to some example embodiments, when this is applied, there may be predefined slot-offsets (e.g., every second, or every fourth), which are made available, and the rest may not be available. According to other example embodiments, when the user equipment (UE) monitors PDCCH corresponding to SS group (1), it may consider monitoring occasions outside the Y slots as invalid, and those overlapping with Y slots may be considered as valid monitoring occasions.

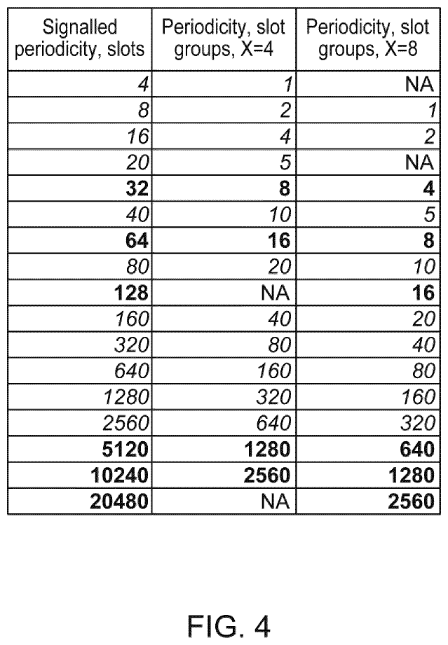

FIG. 4 illustrates an example of a table for monitoringSlotPeriodicityAndOffset_R17, according to certain example embodiments. As illustrated in the example of FIG. 4, the UE may assume that X, Y and the location of Y within X are indicated separately from monitoringSlotPeriodicityAndOffset_R17. According to certain example embodiments, the UE may determine that SS relates to 480 kHz for 960 kHz SCS, and to multi-slot PDCCH monitoring. According to other example embodiments, the UE may receive configuration (from the gNB or centralized unit (CU)) for X, Y, and the location of Y within X. According to further example embodiments, the UE may receive monitoringSlotPeriodicityAndOffset_R17 for a given PDCCH SS (from the gNB or CU). In response, the UE may take certain actions including, for example, determining valid slots/symbols for PDCCH monitoring, and/or determining valid PDCCH candidates according to the UE's capability (such as multi-slot PDCCH monitoring capability and the related (X,Y) configuration).

In certain example embodiments, the indicated values of the SS monitoring periodicity and offset may include various features. For example, for periodicity, the possible values may include the values in monitoringSlotPeriodicityAndOffset (for Rel-15), that are divisible by the integer multiple X (numbers in italics in FIG. 4). In the example of FIG. 4, X corresponds to the size of slot group, which is 4 for 480 kHz, and 8 for 960 kHz.

According to certain example embodiments, the possible values for periodicity may also include values that are integer multiples of the values in monitoringSlotPeriodicityAndOffset (for Rel-15), where the integer multiple is X (numbers in bold in FIG. 4). According to other example embodiments, there may be other values of periodicity that do not meet the above criteria (i.e., the criteria of where the possible values are divisible by the integer multiple X, and values that are integer multiples of values in monitoringSlotPeriodicityAndOffset (for Rel-15), and are excluded (values identified as “NA” in FIG. 3). The UE may consider “NA” as an invalid configuration. According to some example embodiments, for offset, the value may be determined based on the indicated periodicity, such that the offset is indicated on a slot level, or the offset is determined in terms of slot groups of X slots. In this example embodiment, the value range for monitoringSymbolsWithinSlot may be increased by a factor of X.

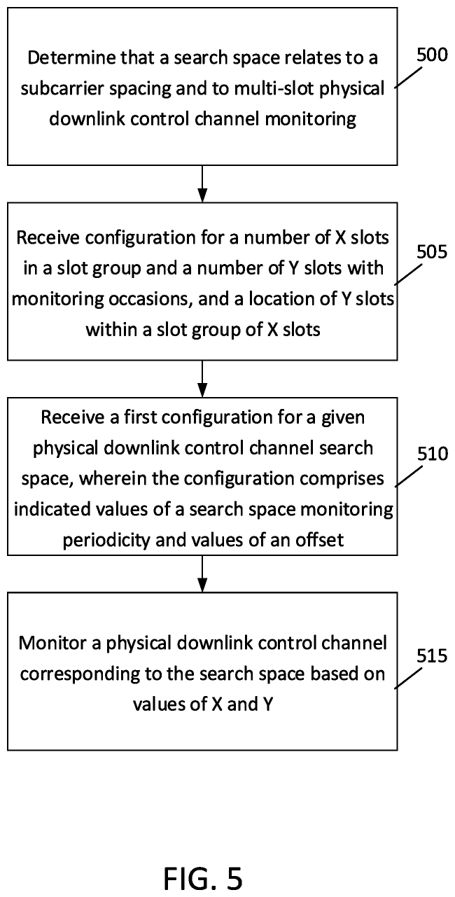

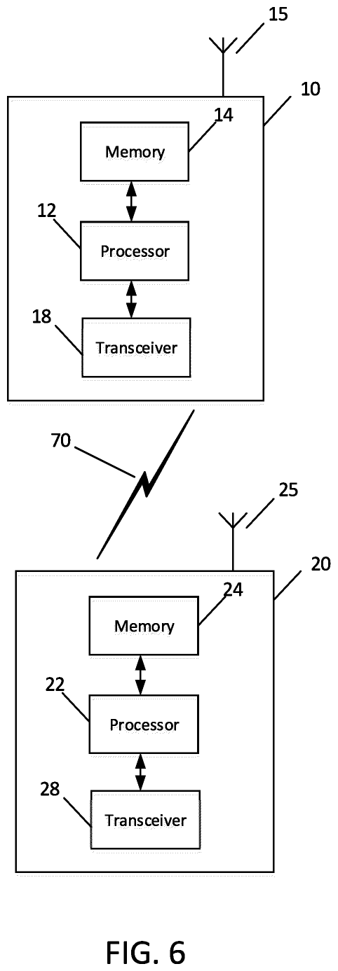

FIG. 5 illustrates an example flow diagram of a method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by a UE similar to one of apparatuses 10 or 20 illustrated in FIG. 6. Other example embodiments may relate to an integrated access backhaul (IAB) where the UE functionalities may be carried out by the mobile termination (MT) part of the IAB node, and the gNB functionalities may be carried out by the distributed unit (DU) part of the IAB node, respectively.

According to certain example embodiments, the method of FIG. 5 may include, at 500, determining that a search space relates to a subcarrier spacing and to multi-slot physical downlink control channel monitoring. The method may also include, at 505, receiving configuration for a number of X slots in a slot group and a number of Y slots with monitoring occasions, and a location of Y slots within a slot group of X slots. The method may further include, at 510, receiving a first configuration for a given physical downlink control channel search space. According to certain example embodiments, the configuration may include indicated values of a search space monitoring periodicity and values of an offset. In addition, the method may include, at 515, monitoring a physical downlink control channel corresponding to the search space based on values of X and Y.

According to certain example embodiments, the offset may be indicated with a resolution of X slots, while a parameter monitoringSymbolsWithinSlot is increased by a factor of X. According to other example embodiments, the indicated values of search space monitoring periodicity may include values in a second configuration that are divisible by an integer multiple of X. According to some example embodiments, the indicated values of search space monitoring periodicity may include values that are integer multiples of values of a second configuration, wherein the integer multiple is X. According to other example embodiments, X may correspond to a slot group size of 4 slots for a subcarrier spacing of 480 kHz, and 8 slots for a subcarrier spacing of 960 kHz. According to certain example embodiments, if the indicated values do not fulfill the criteria of including values in a second configuration that are divisible by an integer multiple of X, and/or including values that are integer multiples of values of a second configuration, wherein the integer multiple is X, the UE may consider the configuration as invalid.

In certain example embodiments, the method may also include excluding values of periodicity that are not divisible by the integer multiple of X, and values of periodicity that are not integer multiples of the values in the second configuration. In some example embodiments, the method may further include determining a slot offset of the search space monitoring. In other example embodiments, the slot offset is restricted to an upper limit value corresponding to a maximum slot offset in case of subcarrier spacing of 120 kHz. According to certain example embodiments, the maximum slot offset may be a value of 2560. In certain example embodiments, the slot offset may be restricted to values that are an integer multiple of X. In further example embodiments, monitoring occasions outside of the Y slots may be classified as invalid monitoring occasions, and monitoring occasions within the Y slots may be classified as valid monitoring occasions.

FIG. 6 illustrates a set of apparatuses 10 and 20, according to certain example embodiments. In certain example embodiments, the apparatus 10 may be a node or element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 6.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 6.

As illustrated in the example of FIG. 6, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 6, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-5.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-5.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to determine that a search space relates to a subcarrier spacing and to multi-slot physical downlink control channel monitoring. Apparatus 10 may also be controlled by memory 14 and processor 12 to receive configuration for a number of X slots in a slot group and a number of Y slots with monitoring occasions, and a location of Y slots within a slot group of X slots. Apparatus 10 may further be controlled by memory 14 and processor 12 to receive a first configuration for a given physical downlink control channel search space. According to certain example embodiments, the configuration may include indicated values of a search space monitoring periodicity and values of an offset. In addition, apparatus 10 may be controlled by memory 14 and processor 12 to a physical downlink control channel corresponding to the search space based on values of X and Y.

In certain example embodiments, apparatus 20 may be a node, core network element, or element in a communications network or associated with such a network, such as a base station, a Node B, an evolved Node B (eNB), 5G Node B or access point, next generation Node B (NG-NB or gNB), and/or WLAN access point, associated with a radio access network (RAN), such as an LTE network, 5G or NR. It should be noted that one of ordinary skill in the art would understand that apparatus 20 may include components or features not shown in FIG. 6.

As illustrated in the example of FIG. 6, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 6, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in one or more of FIGS. 1-4.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in or associated with FIGS. 1-4.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for determining that a search space relates to a subcarrier spacing and to multi-slot physical downlink control channel monitoring. The apparatus may also include means for configuration for a number of X slots in a slot group and a number of Y slots with monitoring occasions, and a location of Y slots within a slot group of X slots. The apparatus may further include means for receiving a first configuration for a given physical downlink control channel search space. According to certain example embodiments, the configuration may include indicated values of a search space monitoring periodicity and values of an offset. In addition, the apparatus may include means for monitoring a physical downlink control channel corresponding to the search space based on values of X and Y.

Certain example embodiments described herein provide several technical improvements, enhancements, and/or advantages. For instance, example embodiments constitute an improvement at least to the technological field of wireless network control and/or management. In some example embodiments, it may be possible to reduce overhead, provide UE power saving, and improve network efficiency. For instance, certain example embodiments may add flexibility in PDCCH SS configuration without excessive signaling overhead. Furthermore, it can be seen as a reasonable solution from implementation complexity and specification impact point of view. Other example embodiments may facilitate multi-slot PDCCH monitoring with increased monitoring periodicity (in terms of slots), while keeping the signaling overhead at the same level as in prior releases. This may provide added benefits in operation with larger subcarrier spacings of 480 and 960 kHz, as the complexity is not increased although larger system bandwidth is supported.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

Partial Glossary:

| | |
|---|---|
| 3GPP | 3rd Generation Partnership Project |
| 5G | 5th Generation |
| 5GCN | 5G Core Network |
| 5GS | 5G System |
| BD | Blind Decoding |
| BS | Base Station |
| CCE | Control Channel Element |
| CN | Core Network |
| CORESET | Control Resource Set |
| CSS | Common Search Space |
| DL | Downlink |
| eNB | Enhanced Node B |
| FR2-2 | Frequency Range 2-2 (57-71 GHz) |
| gNB | 5G or Next Generation NodeB |
| LTE | Long Term Evolution |
| LPP | LTE Positioning Protocol |
| MO | Monitoring Occasions |
| NR | New Radio |
| PDCCH | Physical Downlink Control Channel |
| QCL | Quasi Co-Location |
| QoS | Quality of Service |
| RRC | Radio Resource Control |
| RS | Reference Signal |
| SCS | Subcarrier Spacing |
| SS | Search Space |
| TCI | Transmission Coordination Indicator |
| TDM | Time Division Multiplexing |
| UE | User Equipment |
| UL | Uplink |
| USS | User Specific Search Space Set |

1-52. (canceled)

53. A method, comprising:
determining that a search space relates to a subcarrier spacing and to multi-slot physical downlink control channel monitoring;
receiving configuration for a number of X slots in a slot group and a number of Y slots with monitoring occasions, and a location of Y slots within a slot group of X slots;
receiving a first configuration for a given physical downlink control channel search space, wherein the configuration comprises indicated values of a search space monitoring periodicity and values of an offset; and
monitoring a physical downlink control channel corresponding to the search space based on values of X and Y, wherein X corresponds to a slot group size of 4 slots for a subcarrier spacing of 480 kHz, and 8 slots for a subcarrier spacing of 960 kHz.

54. The method according to claim 53, wherein the offset is indicated with a resolution of X slots, and a parameter monitoringSymbolsWithinSlot is increased by a factor of X.

55. The method according to claim 53, wherein the indicated values of search space monitoring periodicity comprise values in a second configuration that are divisible by an integer multiple of X.

56. The method according to claim 53, wherein the indicated values of search space monitoring periodicity comprise values that are integer multiples of values of a second configuration, wherein the integer multiple is X.

57. The method according to claim 53, further comprising:
excluding values of periodicity that are not divisible by the integer multiple of X, and values of periodicity that are not integer multiples of the values in the second configuration.

58. The method according to claim 53, further comprising:
determining a slot offset of the search space monitoring.

59. The method according to claim 58, wherein the slot offset is restricted to an upper limit value corresponding to a maximum slot offset in case of subcarrier spacing of 120 KHz.

60. The method according to claim 58, wherein the slot offset is restricted to values that are an integer multiple of X.

61. The method according to claim 53, wherein monitoring occasions outside of the Y slots are classified as invalid monitoring occasions, and monitoring occasions within the Y slots are classified as valid monitoring occasions.

62. An apparatus, comprising:
at least one processor; and
at least one memory comprising computer program code,
the at least one memory and the computer program code are configured, with the at least one processor to cause the apparatus at least to
determine that a search space relates to a subcarrier spacing and to multi-slot physical downlink control channel monitoring;
receive configuration for a number of X slots in a slot group and a number of Y slots with monitoring occasions, and a location of Y slots within a slot group of X slots;
receive a first configuration for a given physical downlink control channel search space, wherein the configuration comprises indicated values of a search space monitoring periodicity and values of an offset; and
monitor a physical downlink control channel corresponding to the search space based on values of X and Y, wherein X corresponds to a slot group size of 4 slots for a subcarrier spacing of 480 kHz, and 8 slots for a subcarrier spacing of 960 kHz.

63. The apparatus according to claim 62, wherein the offset is indicated with a resolution of X slots, and a parameter monitoringSymbolsWithinSlot is increased by a factor of X.

64. The apparatus according to claim 62, wherein the indicated values of search space monitoring periodicity comprise values in a second configuration that are divisible by an integer multiple of X.

65. The apparatus according to claim 62, wherein the indicated values of search space monitoring periodicity comprise values that are integer multiples of values of a second configuration, wherein the integer multiple is X.

66. The apparatus according to claim 62, wherein the at least one memory and the computer program code are further configured, with the at least one processor to cause the apparatus at least to:
exclude values of periodicity that are not divisible by the integer multiple of X, and values of periodicity that are not integer multiples of the values in the second configuration.

67. The apparatus according to claim 62, wherein the at least one memory and the computer program code are further configured, with the at least one processor to cause the apparatus at least to:
determine a slot offset of the search space monitoring.

68. The apparatus according to claim 67, wherein the slot offset is restricted to an upper limit value corresponding to a maximum slot offset in case of subcarrier spacing of 120 kHz.

69. The apparatus according to claim 67, wherein the slot offset is restricted to values that are an integer multiple of X.

70. The apparatus according to claim 62, wherein monitoring occasions outside of the Y slots are classified as invalid monitoring occasions, and monitoring occasions within the Y slots are classified as valid monitoring occasions.

71. A non-transitory computer readable medium comprising program instructions stored thereon, which when executed by at least one processor, cause an apparatus at least to:
determine that a search space relates to a subcarrier spacing and to multi-slot physical downlink control channel monitoring;
receive configuration for a number of X slots in a slot group and a number of Y slots with monitoring occasions, and a location of Y slots within a slot group of X slots;
receive a first configuration for a given physical downlink control channel search space, wherein the configuration comprises indicated values of a search space monitoring periodicity and values of an offset; and
monitor a physical downlink control channel corresponding to the search space based on values of X and Y, wherein X corresponds to a slot group size of 4 slots for a subcarrier spacing of 480 kHz, and 8 slots for a subcarrier spacing of 960 kHz.
